(19) United States
(12) Patent Application Publication
(10) Pub. No.: US 2007/0059072 A1
(43) Pub. Date: Mar. 15, 2007

(54) Ink ribbon error record management enabling image forming apparatus and ribbon error record management method thereof

(75) Inventor: Min-Su Park, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/368,534

(22) Filed: Mar. 7, 2006

(30) Foreign Application Priority Data
Aug. 29, 2005 (KR) 2005-0079596

(51) Int. Cl. B41J 29/38; B41J 11/44

(52) U.S. Cl. 400/76

(57) ABSTRACT

Disclosed are an ink ribbon error record management enabling image forming apparatus and a ribbon error record management method is provided. The method includes the steps of: displaying a ribbon cartridge replacement request message when a ribbon error occurs during a printing operation; determining whether a ribbon cartridge is replaced; and storing a ribbon error occurrence record if it is determined that the ribbon cartridge is not replaced. By storing the ribbon error occurrence record, the ribbon error can be displayed even when power is on after being in an off state, and damage to the image forming apparatus can be prevented by allowing an initializing operation and the printing operation to be performed preferably after the ribbon cartridge is replaced.

### PRIORITY

This application claims the benefit under 35 U.S.C. § 119(a) of Korean Patent Application No. 2005-79596, filed on Aug. 29, 2005, in the Korean Intellectual Property Office, the entire disclosure of which is hereby incorporated by reference.

### BACKGROUND OF THE INVENTION

1. Field of the Invention

The present invention relates to an image forming apparatus and a ribbon error record management method thereof. More particularly, the present invention relates to an image forming apparatus and ribbon error record management method capable of protecting itself by storing a ribbon error occurrence record upon an occurring ribbon error and displaying a ribbon cartridge replacement request message to perform a printing operation only when a ribbon cartridge is replaced.

2. Description of the Related Art

An image forming apparatus is an apparatus for outputting print data that has been self-generated or transferred from an external source. The data is produced on print paper, using a developing agent. In general, the image forming apparatus is exemplified by a printer, a copy machine, a facsimile, a multifunction peripheral (MFP) capable of handling several functions of the previous ones in one device.

A thermal transfer printer, which uses an ink ribbon as the developing agent to output the printing data on the print paper, is an example of the image forming apparatus. The ink ribbon refers to an ink-soaked cloth ribbon, and is housed in a cartridge. For example, the thermal transfer printer transfers the ink from the ribbon onto the print paper to output, according to the printing data while the ribbon and the print paper are conveyed in unison in a same direction by a feed roller.

If a paper jam occurs, the print paper is prevented from moving, whereas the ribbon is still conveyed. If the feed roller is stopped suddenly when the paper jam is detected, an error may occur as an indication that the traveling ribbon is broken. This type of ribbon error is usually fixed by replacing a ribbon cartridge.

FIG. 1 illustrates a flowchart provided for explaining a ribbon error management method of a conventional thermal transfer printer.

Referring to FIG. 1, the conventional thermal transfer printer performs a printing operation (S100). The thermal transfer printer determines whether the ribbon error occurs during the printing operation (S110). If it is determined that the ribbon error occurs, the thermal transfer printer displays a ribbon error occurrence message (S120).

However, even when the ribbon cartridge is not replaced, the conventional thermal transfer printer performs the printing operation. Further, the conventional thermal transfer printer does not display the ribbon error occurrence message again, when it is turned on after being in an off state.

The broken ribbon may be damaged in the thermal transfer printer. For example, if the broken ribbon is wound around the feed roller, it will be difficult to carry out repair and to fix the damage to the thermal transfer printer.

Accordingly, there is a need for an improved apparatus and method for recording and managing ink ribbon errors.

### SUMMARY OF THE INVENTION

An aspect of exemplary embodiments of the present invention is to address at least the above problems and/or disadvantages and to provide at least the advantages described below. Accordingly, an aspect of an exemplary embodiment of the present invention is to provide an ink ribbon error record management enabling image forming apparatus and method which is capable of protecting itself by storing a ribbon error occurrence record when a ribbon error occurs, and by performing a printing operation only after it is determined whether a ribbon cartridge is replaced.

Another feature of exemplary embodiments of the present invention is to provide an ink ribbon error record management enabling image forming apparatus and method. The ink ribbon error record management enabling image forming apparatus is capable of protecting itself by storing a ribbon error occurrence record once a ribbon error occurs and by displaying the ribbon error occurrence even when it is turned on after being in an off state, and by performing the printing operation after a determination has been made as to whether the ribbon cartridge has been replaced.

In order to achieve features of exemplary embodiments of the present invention, there is provided a ribbon error record management method of an image forming apparatus, including the steps of: displaying a ribbon cartridge replacement request message when a ribbon error occurs during a printing operation; determining whether a ribbon cartridge is replaced; and storing a ribbon error occurrence record if it is determined that the ribbon cartridge has not been replaced.

Preferably, the ribbon error record management method may further include the step of restarting the printing operation if it is determined that the ribbon cartridge has been replaced.

According to an exemplary embodiment of the present invention, an image forming apparatus includes a storage unit in which a ribbon error occurrence record is stored. The image forming apparatus also includes a control unit which controls such that a ribbon cartridge replacement request message is displayed if it is determined that a ribbon error occurs during a printing operation. Further, the control unit stores a ribbon error occurrence record in the storage unit if it is determined that the ribbon cartridge has not been replaced.

Preferably, the control unit may control such that the printing operation is not performed, if it is determined that the ribbon cartridge is not replaced. Alternatively, the control unit controls such that the printing operation is restarted, if it is determined that the ribbon cartridge has been replaced.

Preferably, the storage unit may be a non-volatile storage medium, and is constituted by at least one of a hard disk, a flash memory, a ferroelectric random access memory (FRAM) and a non-volatile random access memory (NVRAM).

Further, in order to achieve features of exemplary embodiments of the present invention, there is provided a ribbon error record management method of an image forming apparatus. The ribbon error record management method includes the steps of: searching a ribbon error occurrence record when power is applied; displaying a ribbon cartridge replacement request message if the ribbon error occurrence record is searched; determining whether the ribbon cartridge is replaced; and initializing the searched ribbon error occurrence record if it is determined that the ribbon cartridge has been replaced.

Preferably, the ribbon error record management method may further include the step of initializing the image forming apparatus if it is determined that the ribbon cartridge has been replaced.

According to an exemplary embodiment of the present invention, an image forming apparatus includes: a storage unit in which a ribbon error occurrence record is stored; and a control unit which searches the ribbon error occurrence record in the storage unit when power is applied. The control unit controls such that a ribbon cartridge replacement request message is displayed if the ribbon error occurrence record is searched. If it is determined that a ribbon cartridge has been replaced, the control unit initializes the ribbon error occurrence record stored in the storage unit.

Preferably, the control unit may control such that the image forming apparatus is initialized, if it is determined that the ribbon cartridge has been replaced. Alternatively, the control unit controls such that the image forming apparatus is not initialized, if it is determined that the ribbon cartridge has not been replaced.

Preferably, the storage unit may be a non-volatile storage medium, and is constituted by at least one of a hard disk, a flash memory, a ferroelectric random access memory (FRAM) and a non-volatile random access memory (NVRAM).

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a flowchart provided for explaining a ribbon error management method of a conventional thermal transfer printer;

FIG. 2 illustrates a block diagram of a thermal transfer printer according to an exemplary embodiment of the present invention; and

FIG. 3 is a flowchart provided for explaining a ribbon error record management of the thermal transfer printer according to the exemplary embodiment of the present invention.

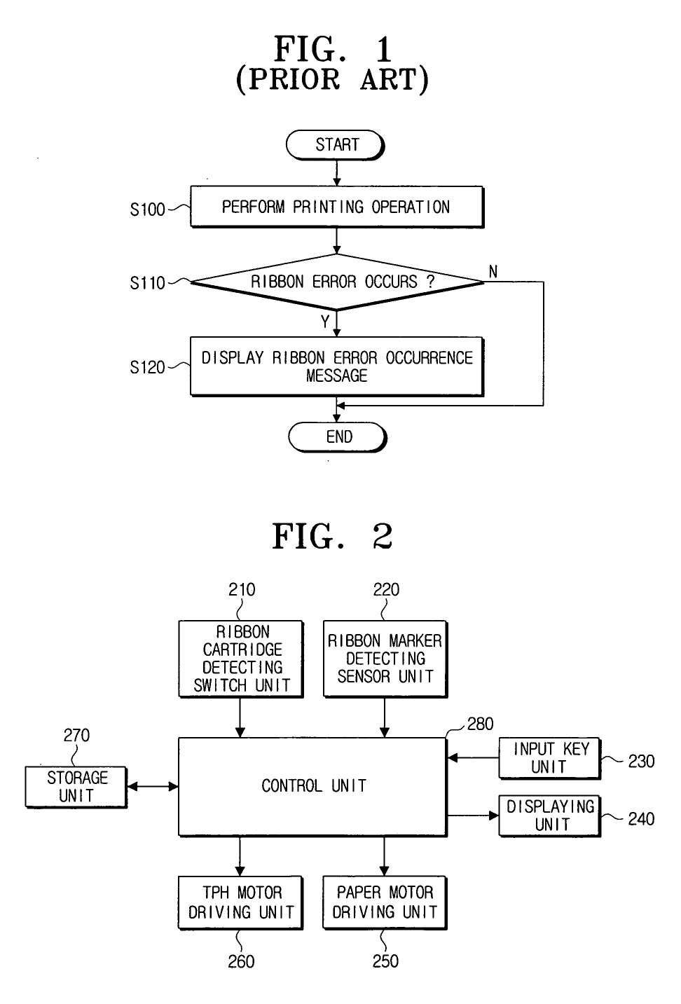

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize the various changes and modifications of the embodiments described herein can be made without departing from the scope and spirit of the invention. Also, descriptions of well-known functions and constructions are omitted for conciseness and clarity.

FIG. 2 is a block diagram of a thermal transfer printer according to an exemplary embodiment of the present invention.

The thermal transfer printer stores a ribbon error occurrence record when a ribbon error occurs. If it is confirmed that a ribbon cartridge has been replaced, the thermal transfer printer deletes the stored ribbon error occurrence record and performs a printing operation.

Further, the thermal transfer printer conducts a search to determine whether the stored error occurrence record exists once it is turned on after being in an off state. If the stored ribbon error occurrence record exists, the thermal transfer printer displays a ribbon cartridge replacement request message. When a ribbon cartridge replacement is confirmed, the thermal transfer printer deletes the stored ribbon error occurrence record and performs the printing operation.

Referring to FIG. 2, the thermal transfer printer includes a ribbon cartridge detecting switch unit 210, a ribbon marker detecting sensor unit 220, an input key unit 230, a displaying unit 240, a paper motor driving unit 250, a thermal print head (TPH) motor driving unit 260, a storage unit 270 and a control unit 280.

The ribbon cartridge detecting switch unit 210 detects a ribbon cartridge (not shown). For example, when the ribbon cartridge is installed, the ribbon cartridge detecting switch unit 210 is turned on to output an ‘on’ signal, and when the ribbon cartridge is removed, it is turned off to output an ‘off’ signal.

The ribbon marker detecting sensor unit 220 detects a marker. For example, the ribbon of one cycle is provided with a strip-shaped cloth soaked with inks of cyan, magenta, yellow, and black color one by one. The ribbon of one cycle is provided with markers, each of which indicate a starting point of each ink. Since the marker for the magenta ink is disposed within a predetermined distance from the marker for the cyan ink, the ribbon marker detecting sensor unit 220 detects the markers for the cyan ink and the magenta ink sequentially to output marker detection signals as the ribbon travels during the printing operation.

The input key unit 230 is for inputting a print command by a user. The displaying unit 240 is for displaying a ribbon cartridge replacement request message.

The paper motor driving unit 250 is for driving a motor conveying a print paper. The TPH motor driving unit 260 is for driving a motor applying heat to the print paper onto which ink is transferred.

In the storage unit 270, the ribbon error occurrence record is stored. The storage unit 270 is a non-volatile storage medium, and can be constituted by at least one of a hard disk, a flash memory, a ferroelectric random access memory (FRAM) and a non-volatile random access memory (NRAM).

The control unit 280 controls the printing operation. If the marker detection signal is inputted from the ribbon marker detecting sensor unit 220 during the printing operation, the control unit 280 determines that the ribbon is in a normal state. On the other hand, if the marker detection signal is not inputted thereto from the ribbon marker detecting sensor unit 220, the control unit 280 determines that the ribbon error is caused by a breakage of the ribbon.

When it is determined that the ribbon error occurs, the control unit 280 controls the displaying unit 240 to display the ribbon cartridge replacement request message.

The control unit 280 determines that the ribbon cartridge is removed, when it is inputted with the ‘off’ signal from the ribbon cartridge detecting switch unit 210. And the control unit 280 determines that the ribbon cartridge is installed, when it is inputted with the ‘on’ signal from the ribbon cartridge detecting switch unit 210. If it is determined that the ribbon cartridge is installed, the control unit 280 determines, based on a serial number and total ink amount of the installed ribbon cartridge and the like, whether the ribbon cartridge has been replaced.

If it is determined that the ribbon cartridge is not replaced, the control unit 280 stores the ribbon error occurrence record in the storage unit 270. At this time, the control unit 280 controls such that the printing operation is not performed even if the print command is inputted thereto.

When the power is turned on after being in an off state, the control unit 280 searches the existence of the ribbon error occurrence record stored in the storage unit 270. If it is determined that the ribbon error occurrence record is searched, the control unit 280 controls the displaying unit 240 to display the ribbon cartridge replacement request message.

Further, after determining whether the ribbon cartridge is replaced, the control unit 280 initializes the ribbon error occurrence record stored in the storage unit 270.

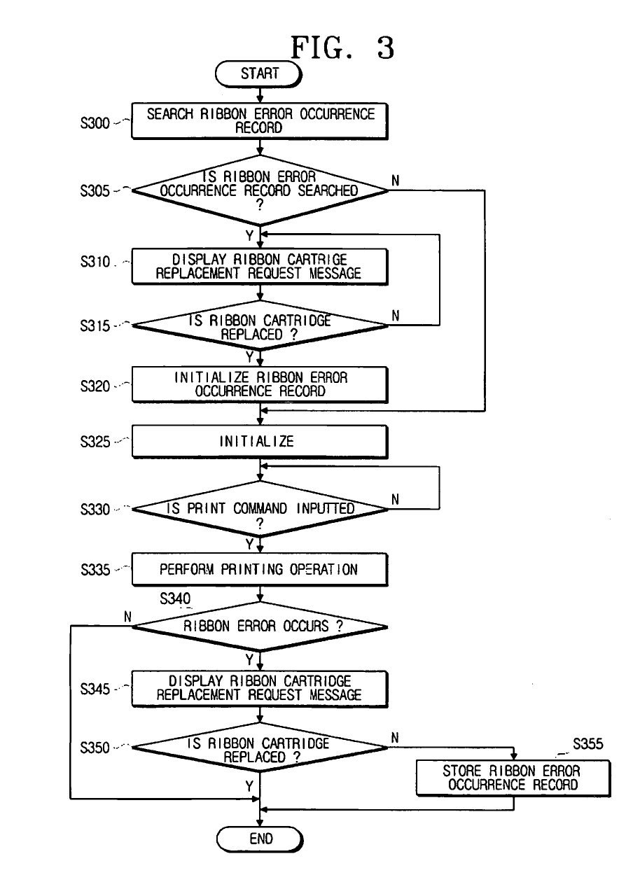

FIG. 3 is a flowchart provided for explaining a ribbon error record management method of the thermal transfer printer in accordance with the exemplary embodiment of the present invention.

Referring to FIG. 3, the control unit 280 searches the ribbon error occurrence record in the storage unit 270 upon application of the power (S300).

The control unit 280 determines whether the ribbon error occurrence record is searched (S305).

If it is determined that the ribbon error occurrence record has been searched, the control unit 280 controls the displaying unit 240 to display the ribbon cartridge replacement request message (S310).

Then, the control unit 280 determines whether the ribbon cartridge is replaced (S315). For example, it can be determined, based on the serial number of the ribbon cartridge, whether the ribbon cartridge replacement is done. In such a case, after the ribbon cartridge is installed, the control unit 280 stores the serial number of the ribbon cartridge in the storage unit 270. Once the control unit 280 receives the ‘on’ signal after the ‘off’ signal from the ribbon cartridge detecting switch unit 210, the control unit 280 compares the serial number stored in the storage unit 270 with that of the presently installed ribbon cartridge. At this time, if the two serial numbers are identical to each other, the control unit 280 determines that the ribbon cartridge has not been replaced. If the two serial numbers are different from each other, the control unit 280 determines that the ribbon cartridge has been replaced.

If it is determined that the ribbon cartridge has not been replaced (S315-N), the control unit 280 controls the displaying unit 240 to continue to display the ribbon cartridge replacement request message in step S310.

If it is determined that the ribbon cartridge has been replaced (S315-Y), the control unit 280 initializes the ribbon error occurrence record stored in the storage unit 270 (S320).

Then, the control unit 280 controls so as to initialize the thermal transfer printer (S325), and determines whether the print command is inputted (S330).

If it is determined that the print command is inputted, the control unit 280 controls the paper motor driving unit 250, the TPH motor driving unit 260 and the like such that the printing operation is performed (S335).

During the printing operation, the control unit 280 determines, based on the marker detection signal inputted from the ribbon marker detecting sensor unit 220, whether the ribbon error occurs (S340). The control unit 280 determines that the ribbon error occurs if the next marker detection signal is not inputted from the ribbon marker detecting sensor unit 220 within a predetermined period of time after the previous marker detection signal is inputted from the ribbon marker detecting sensor unit 220.

If it is determined that the ribbon error occurs, the control unit 280 controls the displaying unit 240 to display the ribbon cartridge replacement request message (S345). Then, the control unit 280 determines whether the ribbon cartridge is replaced (S350).

If it is determined that the ribbon cartridge has not been replaced (S350-N), the control unit 280 stores the ribbon error occurrence record in the storage unit 270 (S355). On the contrary, if it is determined that the ribbon cartridge has been replaced (S350-Y), the control unit 280 controls such that the interrupted printing operation is restarted.

As described above, in accordance with the exemplary embodiment of the present invention, by storing the ribbon error occurrence record, a user can be notified of the ribbon error occurrence even after the image forming apparatus is turned on after being in the off state. Further, the initializing operation and the printing operation are allowed to be performed preferably after the ribbon cartridge is replaced. Accordingly, it is possible to prevent damages which may be caused to the image forming apparatus when the ribbon error occurs.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A ribbon error record management method of an image forming apparatus, comprising:
displaying a ribbon cartridge replacement request message when a ribbon error occurs during a printing operation;
determining whether a ribbon cartridge is replaced; and
storing a ribbon error occurrence record if the ribbon cartridge is not replaced.

2. The ribbon error record management method according to claim 1, further comprising:
restarting the printing operation if the ribbon cartridge is replaced.

3. An image forming apparatus, comprising:
a storage unit for storing a ribbon error occurrence record; and
a control unit for controlling such that a ribbon cartridge replacement request message is displayed if a ribbon error occurs during a printing operation, and for storing a ribbon error occurrence record in the storage unit if the ribbon cartridge is not replaced.

4. The image forming apparatus according to claim 3, wherein the control unit controls such that the printing operation is not performed, if the ribbon cartridge is not replaced, and the control unit controls such that the printing operation is restarted, if the ribbon cartridge is replaced.

5. The image forming apparatus according to claim 3, wherein the storage unit is a non-volatile storage medium, and is constituted by at least one of a hard disk, a flash memory, a ferroelectric random access memory and a non-volatile random access memory.

6. A ribbon error record management method of an image forming apparatus, comprising:
searching a ribbon error occurrence record when power is applied;
displaying a ribbon cartridge replacement request message if the ribbon error occurrence record is searched;
determining whether the ribbon cartridge is replaced; and
initializing the searched ribbon error occurrence record if the ribbon cartridge is replaced.

7. The ribbon error record management method according to claim 6, further comprising:
initializing the image forming apparatus if the ribbon cartridge is replaced.

8. An image forming apparatus, comprising:
a storage unit for storing a ribbon error occurrence record; and
a control unit for searching the ribbon error occurrence record in the storage unit when power is applied,
wherein the control unit controls such that a ribbon cartridge replacement request message is displayed, if the ribbon error occurrence record is searched, and the control unit initializes the ribbon error occurrence record stored in the storage unit, if a ribbon cartridge is replaced.

9. The image forming apparatus according to claim 8, wherein the control unit controls such that the image forming apparatus is initialized, if the ribbon cartridge is replaced, and the control unit controls such that the image forming apparatus is not initialized, if the ribbon cartridge is not replaced.

10. The image forming apparatus according to claim 8, wherein the storage unit is a non-volatile storage medium, and is constituted by at least one of a hard disk, a flash memory, a ferroelectric random access memory and a non-volatile random access memory.
